(19) United States
(12) Patent Application Publication
(10) Pub. No.: US 2009/0222521 A1
(43) Pub. Date: Sep. 3, 2009

(54) Method for Managing Messages In a Peer-To-Peer Network

(76) Inventors: Romaric Petion, Trebeurden (FR); Jean-Christian Villey, Bodou (FR); Didier Neveux, Cavan (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/988,251

(22) PCT Filed: Jun. 29, 2006
(86) PCT No.: PCT/FR2006/050648

§ 371 Date: Jan. 12, 2009

(30) Foreign Application Priority Data
Jul. 1, 2005 (FR) 0507006

(51) Int. Cl. G06F 15/16

(52) U.S. Cl. 709/206; 709/227; 709/226

(57) ABSTRACT

A message management method, for use when a depositor (X) wishes to send a message (M) to an addressee (Y), includes a step of the depositor (X) sending a call invitation (INV1) to a call router (10) to set up a call to the addressee (Y), a step of the router (10) identifying a depositary peer in a peer-to-peer network (1) that is available and has sufficient resources (HD) for storing the message (M), and a step of setting up a communication stream (FC) between the depositor (X) and the depositary (PR) for storing the message in the resources (HD) of the depositary peer.

### BACKGROUND OF THE INVENTION

The present invention relates to a message service and more particularly to a method of managing messages in a peer-to-peer telecommunications network.

According to the invention, messages are recorded in peers of the peer-to-peer network but it is not necessary for the devices that deposit messages or to which messages are sent to be peers of that network themselves.

The invention can be used in particular for voice or videophone messages.

More generally, a message can consist of any computer file.

In the field of voice or videophone messages, there are at present two main solutions for depositing a message for a called party if their terminal is busy or they do not answer.

Firstly there are standard videophone answering machines connected to the destination terminal. This solution has a major drawback, however, because it requires the acquisition of dedicated hardware (the answering machine) for receiving and recording messages. What is more, the answering machine can only be contacted if the destination terminal itself is accessible.

That unsatisfactory solution cannot form the basis of a service offered by a telecommunications network operator.

Also known is a service available from telecommunications operators enabling a caller to deposit a message on a messaging platform managed by the operator.

The major drawback of that second solution is that the messaging platform is a centralized point in the architecture of the telecommunications network.

Centralization obviously makes that technical solution weak in the face of an attack or malfunction, managing it costly, and dimensioning it problematical.

### OBJECT AND SUMMARY OF THE INVENTION

The present invention, based on a peer-to-peer architecture telecommunications network, eliminates the drawbacks referred to above.

In this kind of architecture, each peer terminal of the network can function as server or client at the same time, as is known in itself.

A first aspect of the invention is directed to a message management method in which a first device referred to as the “depositor” seeks to send a message to a second device referred to as the “addressee”. This method includes the following steps:
the depositor sending a first call request to a call router connected to a peer-to-peer network in a signaling stream to set up a call to the addressee;
the router detecting that the addressee is not available to set up the call;
identifying a peer of the peer-to-peer network referred to as the “depositary peer” that is available and has sufficient resources to record the message;
the router sending a second call request to the depositary peer in the signaling stream to set up a communication stream between the depositor and the depositary peer;
the depositor sending the message to the depositary peer in the communication stream;
the depositary peer storing the message in the aforementioned resources;
notifying the addressee of an indication representing the fact that a message sent thereto is stored in the peer-to-peer network; and
the addressee obtaining the message from the peer-to-peer network.

The invention therefore has the advantage of using the abundant resources of the peers of the network, thus eliminating infrastructure (maintenance, computation, storage) costs for the operator.

In the particular circumstance where the peers are computers, the messages are in practice stored on the hard disks of the computers.

Thus the invention has the advantage of not requiring the acquisition of a dedicated answering machine, the peers consisting in practice of personal computers connected to the network for other purposes (in particular for Internet access).

Note at this point that the depositing device and the destination device are not necessarily peers of the network.

This feature is particularly advantageous since the messaging service can be used by any calling party, and in particular for calls from third-party networks.

Note also that the invention differs from known information sharing systems on peer-to-peer networks (in particular the KAZAA system) as the messages deposited are intended for a particular addressee.

A second aspect of the invention is directed to a call router for implementing the above message management method.

That call router includes:
means for receiving a first call request from a first device referred to as the “depositor” in a signaling stream, the depositor seeking to set up a call to a second device referred to as the “addressee” to send it a message;
means for detecting that the addressee is not available to set up the call;
means for connecting to a peer-to-peer network and for communicating with peers of that network;
means for identifying in the peer-to-peer network a peer referred to as the “depositary peer” that is available and has sufficient resources to record the message;
means for sending a second call request to the depositary peer in the signaling stream to set up a communication stream between the depositor and the depositary peer; and
means for setting up the communication stream as a function of the response to the second call request.

Thus the call router according to the invention has two main functions: firstly identifying an available peer having sufficient resources to record a message; and secondly setting up a communication stream between the depositing device and the depositary peer.

In a correlated way, the invention consists in a call routing method including:
a step of receiving a first call request in a signaling stream from a first device referred to as the “depositor” seeking to set up a call to a second device referred to as the “addressee” to send it a message;
a step of detecting that the addressee is not available to set up the call;
a step of identifying in a peer-to-peer network a peer referred to as the “depositary peer” that is available and has sufficient resources to record the message;
a step of sending a second call request to the depositary peer in the signaling stream to set up a communication stream between the depositor and the depositary peer; and
a step of setting up the communication stream as a function of the response to the second call request.

The routing method according to the invention can be implemented in a call router as referred to above.

Alternatively, the method can be implemented in a distributed manner by peers of the network.

In one particular implementation of the invention, the signaling protocol preferably conforms to the Session Initiation Protocol (SIP) defined by the Internet Engineering Task Force (IETF) document RFC 3261.

Any other signaling protocol can be used instead, and in particular the MGCP and H323 protocols.

The call router according to the invention preferably includes:
means for receiving from a peer of the peer-to-peer network an indication of the fact that the peer is adapted to implement a message storage method; and
means for maintaining a list of peers adapted to implement said message storage method.

In a first embodiment, this indication is broadcast spontaneously by the peers of the network adapted to implement a message storage method.

In another embodiment, the call router is adapted to send a request to a peer device to find out whether it can implement the message storage method and where applicable to receive the aforementioned indication in response to that request.

The identification means of the call router are preferably adapted:
to preselect the depositary peer in the aforementioned list; and
to send the depositary peer over the peer-to-peer network an enquiry to verify whether it is available and actually has resources available for recording the message.

By means of this feature, the call router guarantees that the depositary peer is actually available and has the necessary resources at the time of recording the message.

The person skilled in the art will realize that this enquiry can be of two types. A first type of enquiry explicitly asks if resources for recording the message are available in the depositary peer. A second type of enquiry asks for the amount of resources available and the call router itself determines if they are sufficient for the depositary peer to be able to record the message.

In one embodiment, if the call router determines that the resources are sufficient, it can also explicitly send a request to reserve the resources of the depositary peer necessary to receive and store the message.

The call router preferably inserts into the reservation request an identifier of the depositor and the addressee of the message.

As described in detail below, these identifiers can in particular enable the depositary peer to generate a personalized invitation message to the message depositor.

The identifier of the addressee can also enable the depositary peer to contact the addressee later to notify that the message has been recorded.

In a preferred embodiment, the call router includes means for obtaining a message record status report from the depositary peer via the peer-to-peer network and means for sending that status report to the depositor in the signaling stream.

According to this advantageous feature, the call router controls the status of messages recorded in the peer-to-peer network and is in a position to contact addressees to notify them of recorded messages intended for them.

The identification means of the call router are preferably adapted to select the depositor as the depositary peer if the depositor is a peer of the peer-to-peer network and has available capacity for recording the message.

This feature is advantageously used to set up a local communication stream within the depositor peer which firstly avoids congestion on the telecommunications network and secondly makes the recording of the message secure, as it is effected locally.

The identification means of the call router are preferably also adapted to select the addressee as the depositary peer if it is a peer of the peer-to-peer network and has available capacity for recording the message.

The person skilled in the art will realize that this feature can be used when a communications stream to the destination peer can be set up but said peer is not available to receive the message from the depositor directly.

If the depositor and the addressee are both depositary peers with available capacity for recording the message, the call router preferably selects the addressee to record the message, thus guaranteeing that the message is recorded in the resources of the addressee, who can recover the message later, even if the depositor is no longer available.

A third aspect of the invention is directed to a device adapted to be connected to a peer-to-peer network to implement the above message management method.

That device includes:
means for sending over the peer-to-peer network an indication that it is adapted to implement a message storage method;
means for reserving resources necessary for recording a message on reception of a reservation request message over the peer-to-peer network;
means for receiving a call request from a call router in a signaling stream to set up a communication stream with a first device referred to as the “depositor” via the router; and
means for receiving the message from the depositor in the communication stream and for storing the message in the aforementioned resources.

In a correlated manner, the invention consists in a message storage method adapted to be implemented by a peer device in a peer-to-peer network. That method includes:
a step of sending over the peer-to-peer network an indication that the device is adapted to implement a message storage method;
a step of receiving a request for reservation of resources of the device necessary for recording a message;
a step of reserving the resources;
a step of receiving a call request from a call router in a signaling stream to set up a communication stream with a first device referred to as the “depositor”; and
a step of receiving the message from the depositor in the communication stream and storing the message in the aforementioned resources.

As mentioned above, the depositary device according to the invention is preferably adapted to generate an invitation message from the identifier of the addressee extracted from the reservation request received from the call router and to send that invitation message to the depositor in the communication stream.

In a preferred embodiment, the depositary device according to the invention further includes means for fragmenting the message into a plurality of portions and for identifying peers of the peer-to-peer network able to store a replica of the message or a portion or portions thereof.

The person skilled in the art will realize that fragmenting the message in particular increases the speed of downloading the message by the addressee. It therefore guarantees the ongoing presence of the message portions in the event of disconnection of peers.

Moreover, replicating the message, in whole or in part, on different peers ensures continuity of the messaging service, even if one of the depositary peers is down.

The depositary peer according to the invention preferably includes means for extracting from the reservation request an identifier of the addressee of the message and means for generating an identifier of the message and where applicable of each portion of the message.

The peer device according to the invention preferably includes means for sending the depositor an acknowledgement message in the communication stream and/or an acknowledgement indication on the signaling channel if the message has been stored successfully.

This acknowledgement indication (respectively acknowledgement message) reassures the depositor of successful recording of the message.

In a preferred embodiment, the peer device according to the invention includes means for sending the call router a second acknowledgement indication via the peer-to-peer network if the message has been stored successfully.

In a preferred embodiment, the depositary peer according to the invention includes means for sending the depositor a ringing tone message in the communication stream and/or a ringing tone indication on the signaling channel throughout the time period for which the communication stream is set up.

This ringing tone indication (or message) can consist of a small visual animation that is executed on the terminal of the depositor, for example.

In a preferred embodiment, the depositary device according to the invention includes the standard functions of a telephone answering machine.

In a preferred embodiment, the depositary device therefore includes means for sending a confirmation message in the communication stream to invite the user of the depositor device to listen to, modify or delete the message and means for forwarding the message in the communication stream or replacing it or deleting it in the aforementioned resources as a function of the response to the confirmation message.

In a preferred embodiment, the steps of the routing method and/or the storage method are determined by instructions of computer programs.

Consequently, the invention is also directed to a computer program on an information medium adapted to be executed in a call router or a computer and including instructions for executing the steps of the above routing method when it is executed by the call router or the computer.

The invention is further directed to a computer program on an information medium, adapted to be executed in a computer, and including instructions for executing the above storage method when it is executed by the computer.

These programs can use any programming language and take the form of source code, object code or an intermediate code between source code and object code, such as a partially compiled form or any other desirable form.

The invention is also directed to a computer-readable medium containing instructions for executing the steps of the above routing method or storage method.

The information medium can be any entity or device capable of storing the program. For example, the medium can comprise storage means such as a ROM, for example a CD ROM or a microelectronic circuit ROM, or magnetic storage means, for example a diskette (floppy disk) or a hard disk.

Moreover, the information medium can be a transmissible medium such as an electrical or optical signal which can be routed via an electrical or optical cable, by radio or by other means. The program according to the invention can in particular be downloaded over an Internet-type network.

Alternatively, the information medium can be an integrated circuit incorporating the program and adapted to execute the method in question or to be used in the execution thereof.

### BRIEF DESCRIPTION OF THE DRAWINGS

Other features and advantages of the present invention will emerge from the description given below with reference to the appended drawings, which show one non-limiting embodiment of the invention. In the figures:

FIG. 1 shows a call router and a depositary device, both conforming to the invention, and the information exchanged between the equipment units involved in storing a message in accordance with a preferred embodiment of the message management method of the invention;

FIG. 2 shows in the form of a flowchart the main steps of a call routing method conforming to a preferred embodiment of the invention; and

FIG. 3 shows in the form of a flowchart the main steps of a message storage method conforming to a preferred embodiment of the invention.

### DETAILED DESCRIPTION OF ONE EMBODIMENT

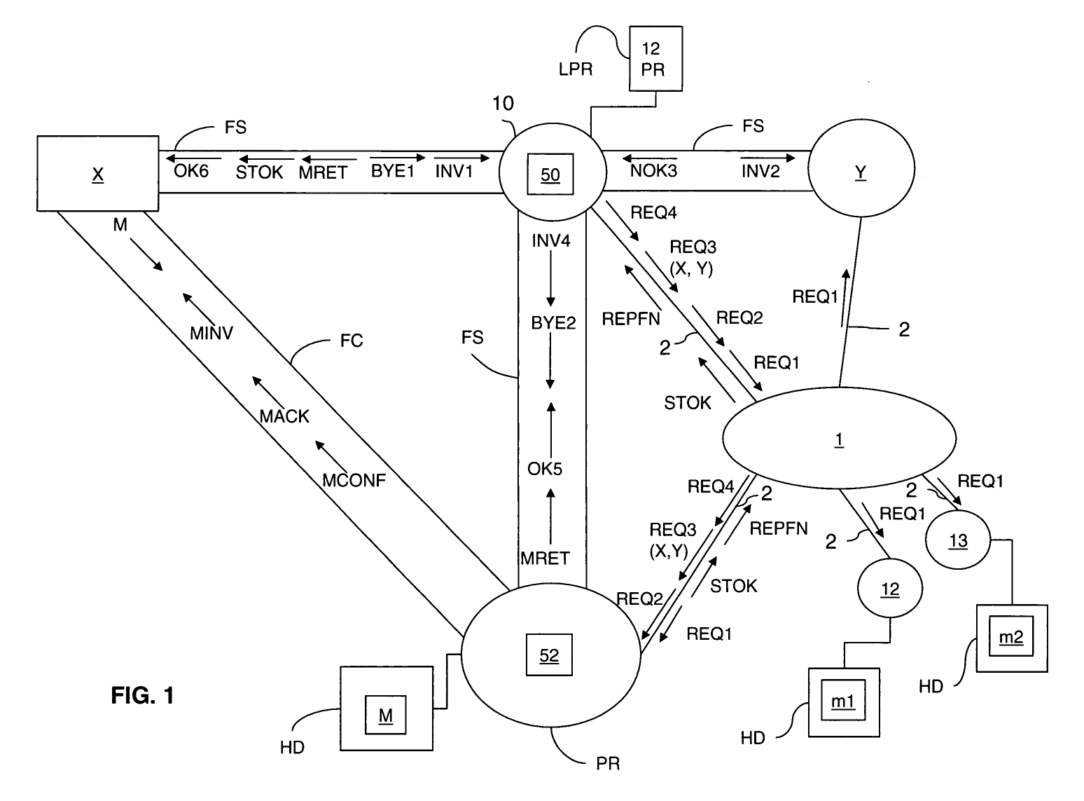

FIG. 1 shows a peer-to-peer network 1 to which peer devices 10, PR, Y, 12, and 13 are connected.

In this figure, the equipment units represented by circles or ovals are peer devices. They are connected to the peer-to-peer network 1 by connections 2.

Each of these peer devices is typically a computer, and for clarity their known processing means (CPU, ROM, RAM, etc.) are not shown.

This figure shows the storage means HD (for example hard disks) of the peer devices PR, 12, and 13.

This example assumes that the peer device 12 and the peer device PR are adapted to implement a message storage method according to the invention.

These devices therefore include a storage medium 52 (for example a memory) which stores a computer program PG2 including instructions for executing the steps of the storage method of which FIG. 3 is a flowchart.

Assume now that the device X, which is referred to as the “depositor”, is seeking to send a message M to the device Y, which is referred to as the “addressee”.

In the preferred embodiment described here, the devices X and Y use the Session Initiation Protocol (SIP) as the call control protocol.

The depositor device X and the addressee device Y are known to the person skilled in the art and do not form part of the invention. They can consist of telephone or videophone terminals, for example.

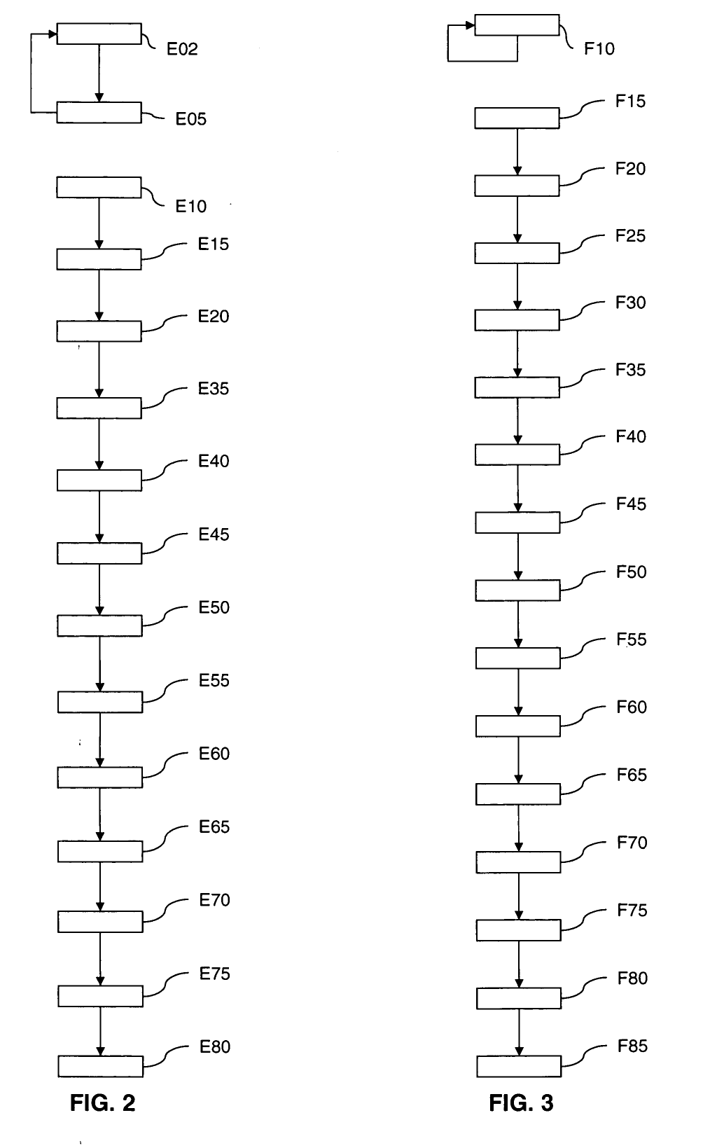

In contrast, the SIP proxy 10 is a call router conforming to the invention. It includes a memory 50 which stores a computer program PG1 comprising instructions for executing steps of the call routing method according to the invention of which FIG. 2 is a flowchart.

As already mentioned above, the SIP proxy 10 is connected to the peer-to-peer network 1 by a connection 2.

In the preferred embodiment described here, the SIP proxy 10 maintains a list LPR of the peers 12, PR adapted to implement the message storage method according to the invention.

To this end, during a step E02, the SIP proxy 10 regularly sends a request REQ1 to all the peers of the peer-to-peer network 1 to obtain the identifiers 12, PR of the peers implementing the message storage method.

That request REQ1 is received during a step F10, in particular by the peer devices PR and 12. During the same step, these peer devices PR, 12 respond to the request REQ1 with information REPFN received by the SIP proxy 10 in the step E05.

During the same step E05, the SIP proxy 10 updates the list LPR of peers.

Alternatively, the peer devices implementing the message storage method can send the information REPFN spontaneously to the SIP proxy 10, which whereupon updates the list LPR.

The SIP proxy 10 preferably sends the request REQ1 regularly in the step E02 so that the list LPR can be kept up to date. In particular, if a peer device previously stored in the list LPR does not respond to the request REQ1, the SIP proxy 10 deletes the entry in the list LPR corresponding to that peer.

The depositor device X, seeking to set up a call to the addressee Y, sends a request INV1 to the call router 10, here consisting of a SIP proxy server, via its SIP client.

The SIP proxy 10 has a standard proxy server function. Consequently, when it receives the request INV1 (step E10), it sends a call request INV2 to the addressee Y in the signaling stream FS (step E15).

It is assumed here that the addressee Y is busy or at least unable to receive the message from the depositor. X. In accordance with the Session Initiation Protocol, the SIP client of the addressee Y sends a NOK3 response to the SIP proxy 10.

In the conventional way, the SIP proxy knows statically the address of the voicemail server to which to forward the call from the depositor X. However, in the present invention, that address is not known a priori to the proxy 10. It must therefore be looked up dynamically.

Thus on reception of the failure notification NOK3 (step E20), the call router 10 sends a depositary peer PR registered in the list LPR a request REQ2 to verify if it is available and has resources for recording the message M (step E35).

This example assumes that the call router 10 initially sends this request REQ2 to the peer device 12 but said device is not available because it has been disconnected from the peer-to-peer network 1.

At the end of a certain time, receiving no response to the request REQ2, the proxy 10 sends the request REQ2 to another depositary peer PR from the list LPR. That request REQ2 is received by the depositary peer PR during a step F15 of the message storage method according to the invention.

It is assumed that during the same step F15 the depositary pair PR sends an indication that it has sufficient resources to record a message M back to the proxy 10 via the peer-to-peer network 1.

The call router 10 receives this response during a step E40.

During the same step, the call router 10 sends a request REQ3 to the depositary peer PR via the peer-to-peer network 1 to request it to reserve resources for recording a message M.

In the example described here, those resources consist of a memory area on the hard disk HD of the peer PR.

This resource reservation request REQ3 includes the identifier X of the depositor and the identifier Y of the addressee of the message M.

The request REQ3 is received during a step F20 by the depositary peer PR, which reserves resources on its hard disk HD during a step F25.

This step F25 is followed by a step F30 during which the depositary device PR sends a positive response to the SIP proxy 10 via the peer-to-peer network 1.

The SIP proxy receives the positive response during a step E45.

During the same step E45, having identified the peer device PR as available and having resources reserved for recording a message, the SIP proxy 10 sends a SIP request INV4 to the depositary peer PR via the signaling stream FS.

The depositary peer PR receives this request INV4 during a step F35.

The example described here assumes that the depositary peer PR accepts this invitation because the necessary resources have been reserved beforehand (step E25).

The depositary peer PR sends an SIP acknowledgement notification OK5 to the SIP proxy 10 in the signaling stream FS during a step F40.

The SIP proxy receives this notification OK5 via the signaling channel FS during a step E50.

The SIP proxy 10 can then set up the call between the depositor X and the depositary peer PR during a step E55 by sending the depositor X an SIP acknowledgement notification OK6 on the signaling channel FS during a step E55.

A media stream or communication stream FC is therefore set up between the depositor X and the depositary peer PR (step E60).

To protect confidentiality, it is preferable for all information in transit in the media stream FC to be encrypted.

In the embodiment described here, as soon as the communication stream FC has been set up, the depositary peer PR begins to send a ringing tone indication MRET to the SIP proxy 10 in the signaling stream FS (step F45). The SIP proxy 10 sends this ringing tone indication MRET to the depositor X (step E65).

On reception of this ringing tone indication, the device X illuminates a flashing LED, for example.

A ringing tone message MRET can instead be sent to the device X via the communication stream FC.

Be this as it may, this ringing tone indication or message MRET is maintained throughout the period of time for which the communication stream FC is set up.

This ringing tone message MRET sending step F45 is followed by a step F50 during which the peer device PR extracts the identifiers X of the depositor and Y of the addressee from the request REQ3 received during the step F30.

This extraction step F50 is followed by a step F55 during which the peer device PR generates an invitation message MINV and sends it to the depositor X in the communication stream FC. This invitation message MINV can optionally be personalized using the identifier Y of the addressee.

The user of the device X receives the invitation message MINV during a step E70. On reception of this message, they begins to send their message M so that it is recorded in the resources HD of the depositary peer device PR.

The message M is received on the communication channel FC and stored by the depositary peer device PR during a step F60. When recording of the message has been completed, which end of recording condition can be detected as a period of silence or the user pressing a DTMF key, for example, the depositary peer device PR sends an acknowledgement message MACK to the depositor X during a step F65.

In the example described here, this acknowledgement message MACK is sent in the communication stream FC.

Alternatively, an acknowledgement indication can be sent via the call router 10 in the signaling stream FS.

Recording of the message M is finished, but in the preferred embodiment described here the peer device PR sends a confirmation message MCONF on the communication channel FC during a step F70 inviting the user of the depositor device X to listen to, modify or delete the message M.

It is assumed that the user does not use this facility and terminates the call to the depositary peer PR, for example by hanging up.

This on-hook state is detected by the SIP proxy 10 during a step E75 on receiving in the signaling stream a SIP message BYE1 (reflecting the device X hanging up). The proxy 10 then sends the message BYE2 to the depositary peer PR.

The depositary peer PR, having received the message BYE2, ceases to send the ringing tone indication MRET on the signaling channel FS during a step F75.

In the embodiment described here, the message M is then split and replicated on the peer-to-peer network.

To this end, during a step F80, the depositary peer PR fragments the message M that was recorded during the step F60 into a plurality of portions, two portions (m1 and m2) in the present example, the identifier Y extracted from the request REQ3 during the step F50 being used to generate an identifier of the message portions.

During the same step F80, the depositary peer PR identifies a number of peers of the peer-to-peer network 1, two peers (12 and 13) in the present example, to store the message portions m1 and m2 independently of each other.

During a step E80, the SIP proxy 10 sends a request REQ4 to the depositary peer PR via the peer-to-peer network 1 to determine the storage status of the message in the peer-to-peer network.

The depositary peer PR receives this request REQ4 during a step F85.

In the example described here, recording of the message having been completed successfully, the peer device PR sends an STOK status report to the SIP proxy 10 during the step F80.

This status report is received by the proxy 10 during the step E80.

In the preferred embodiment described here, if the addressee peer Y is reconnected to the peer-to-peer network, using a method known to the person skilled in the art, it searches the peer-to-peer network for any messages of which it is the addressee, i.e. messages identified by its identifier Y.

The addressee Y can then obtain the message M by any means known to the person skilled in the art (download, telephone call to a voicemail server, etc.).

1. A message management method in which a first device (X) referred to as the “depositor” seeks to send a message (M) to a second device (Y) referred to as the “addressee”, comprising the steps of:
said depositor (X) sending a first call request (INV1) to a call router (10) in a signaling stream (FS) to set up a call with said addressee (Y), wherein the router is connected to a peer-to-peer network (1);
said router (10) detecting that said addressee (Y) is not available to set up said call;
said router (10) identifying a peer (PR) of said peer-to-peer network (1) referred to as the “depositary peer” that is available and has sufficient resources (HD) to record said message (M);
said router (10) sending (E45) a second call request (INV4) to said depositary peer (PR) in said signaling stream (FS) to set up a communication stream (FC) between said depositor (X) and said depositary peer (PR);
said depositor (X) sending said message (M) to said depositary peer (PR) in said communication stream (FC);
said depositary peer (PR) storing (F60) said message (M) in said resources (HD);
notifying said addressee (Y) of an indication representing the fact that a message (M) sent thereto is stored in said peer-to-peer network (1); and
said addressee (Y) obtaining said message (M) from the peer-to-peer network (1).

2. A call router (10) comprising:
means for receiving a first call request (INV1) from a first device (X) referred to as the “depositor” in a signaling stream (FS), said depositor (X) seeking to set up a call to a second device (Y) referred to as the “addressee” to send it a message (M);
means for detecting that said addressee (Y) is not available to set up said call;
means for connecting to a peer-to-peer network (1) and for communicating with peers (12, 13, PR, Y) of that network (1);
means for identifying in said peer-to-peer network (1) a peer referred to as the “depositary peer” (PR) that is available and has sufficient resources (HD) to record said message (M);
means for sending a second call request (INV4) to said depositary peer (PR) in said signaling stream (FS) to set up a communication stream (FC) between said depositor (X) and said depositary peer (PR); and
means for setting up said communication stream (FC) as a function of the response (OK5) to said second call invitation (INV4).

3. The call router according to claim 2, comprising:
means for receiving from a peer of said peer-to-peer network (1) an indication (REPFN) of the fact that said peer is adapted to implement a message storage method; and
means for maintaining a list (LPR) of peers adapted to implement said message storage method.

4. The call router according to claim 2, wherein said identification means are adapted to send said depositary peer (PR) over said peer-to-peer network (1) a request (REQ3) to reserve the resources of said depositary peer (PR) necessary to receive and store said message (M).

5. The call router according to claim 2, comprising means for obtaining from said depositary peer (PR) via said peer-to-peer network (1) a storage status report (STOK) in respect of said message (M) and means for sending that status report (STOK) to said depositor (X) in said signaling stream (FS).

6. A device (PR) adapted to be connected to a peer-to-peer network (1), comprising:
means for sending over said peer-to-peer network (1) an indication (REPFN) that it is adapted to implement a message storage method;
means for reserving resources (HD) necessary for recording a message (M) on reception of a reservation request message (REQ3) over said peer-to-peer network (1);
means for receiving a call request (INV4) from a call router (10) in a signaling stream (FS) to set up a communication stream (FC) with a first device (X) referred to as the “depositor”; and
means for receiving said message (M) from said depositor (X) in said communication stream (FC) and for storing said message (M) in said resources (HD).

7. The device (PR) according to claim 6, comprising means for extracting from said reservation request (REQ3) an identifier (Y) of the addressee (Y) of said message (M) and means for generating an invitation message (MINV) from said identifier (Y) and sending that invitation message (MINV) to said depositor (X) in said communication stream (FC).

8. The device (PR) according to claim 6, comprising means for extracting from said reservation request (REQ3) an identifier (Y) of the addressee (Y) of said message (M) and means for generating from said identifier (Y) an identifier of said message (M) and where applicable of each portion (m1, m2, mi) of said message (M).

9. The device (PR) according to claim 6, comprising means for sending said depositor (X) an acknowledgement message (MACK) in said communication stream (FC) and/or an acknowledgement indication (MACK) in said signaling stream (FS) if said message (M) has been stored successfully.

10. The device (PR) according to claim 6, comprising means for sending a confirmation message (MCONF) in said communication stream (FC) to invite the user of said depositor device (X) to listen to, modify or delete said message (M) and means for forwarding said message (M) in said communication stream (FC) or replacing it or deleting it in said resources (HD) as a function of the response to said confirmation message (MCONF).

11. A call routing method comprising:
a step (E10) of receiving a first call request (INV1) in a signaling stream (FS) from a first device (X) referred to as the “depositor” (X) seeking to set up a call to a second device (Y) referred to as the “addressee” to send it a message (M);
a step (E20) of detecting that said addressee (Y) is not available to set up said call;
a step of identifying in a peer-to-peer network (1) a peer (PR) referred to as the “depositary peer” that is available and has sufficient resources (HD) to record said message (M);
a step (E45) of sending a second call request (INV4) to said depositary peer (PR) in said signaling stream (FS) to set up a communication stream (FC) between said depositor (X) and said depositary peer; and
a step (E60) of setting up said communication stream (FC) as a function of the response (OK5) to said second call request (INV4).

12. A computer program (PG1) including instructions for executing the steps of the call routing method according to claim 11 when said program is executed by a computer.

13. A computer-readable storage medium (50) on which is stored a computer program (PG1) including instructions for executing the steps of the call routing method according to claim 11.

14. A message storage method adapted to be implemented by a peer device (PR) in a peer-to-peer network (1), comprising:
a step (F10) of sending over said peer-to-peer network (1) an indication (REP_FN) that said device (PR) is adapted to implement a message storage method;
a step (F20) of receiving a request (REQ3) for reservation of resources (HD) of said device (PR) necessary for storing a message (M);
a step (F25) of reserving said resources (HD);
a step (F35) of receiving a call request (INV4) from a call router (10) in a signaling stream (FS) to set up a communication stream (FS) with a first device (X) referred to as the “depositor”; and
a step (F60) of receiving said message (M) from said depositor (X) in said communication stream (FC) and storing the message (M) in said resources (HD).

15. A computer program (PG2) including instructions for executing the steps of the message storage method according to claim 14 when said program is executed by a computer.

16. A computer-readable storage medium (52) on which is stored a computer program (PG2) including instructions for executing the steps of the message storage method according to claim 14.
